(19) United States
(12) Patent Application Publication
(10) Pub. No.: US 2007/0031653 A1
(43) Pub. Date: Feb. 8, 2007

(54) Multi-layer barrier film structure

(75) Inventor: Tien-Kuei Su, Saunderstown, RI (US)

Correspondence Address: MORRISON & FOERSTER LLP, 1650 TYSONS BOULEVARD, SUITE 300, MCLEAN, VA, 22102, US

(73) Assignee: Toray Plastics (America), Inc., N. Kingstown, RI (US)

(21) Appl. No.: 11/194,768

(22) Filed: Aug. 2, 2005

(51) Int. Cl. B32B 27/18; B32B 15/08; B32B 27/08; B32B 27/32

(52) U.S. Cl. 428/336; 428/523; 428/515; 428/522; 428/457

(57) ABSTRACT

A laminate film including a polyetheramine resin-containing layer that has at least 30% resorcinol diglycidyl ether comonomer content, and a first polyolefin resin-containing layer which includes an amount of a tie-layer resin additive is disclosed. The laminate film could further have additional layers such as a second polyolefin resin-containing layer, a metal layer, or combinations thereof.

### FIELD OF INVENTION

This invention relates to a biaxially oriented films that include a polyolefin tie-layer, a layer of polyetheramine polymer contiguously formed on one side of the polyolefin tie-layer, and an optional contiguous polyolefin layer formed on the polyolefin tie-layer side opposite the polyetheramine polymer.

### BACKGROUND OF INVENTION

Ethylene vinyl alcohol copolymers (EVOH) show excellent oxygen and flavor barrier properties at low humidity, typically in the range of 0 to 60%. However, their barrier property deteriorates dramatically under high humidity conditions when the humidity is in the range of 75 to 90%. In fact, due to the polar nature of EVOH, such films generally exhibit poor moisture barrier. Therefore, EVOH is typically laminated with polyolefins on both sides to provide barrier properties for practical packaging applications in order to protect the EVOH from humidity effects. Moreover, EVOH is relatively brittle and difficult to stretch, tending to form cracks during stretching in biaxial orientation processes, for example, due to its crystalline nature. In biaxial orientation processes, EVOH grades that are suitable for stretching are typically limited to 48 mole % ethylene content. Lower ethylene content EVOH grades—which often exhibit better gas barrier properties—are unusable in orientation processes due to the brittle nature of these materials, which will crack or fracture under the stretching forces involved. EVOH materials also require the use of adhesion promoters and/or tie-layer resins in order for them to bond adequately to polyolefin substrates. Without such tie resins, EVOH materials or related materials like polyviny alcohol (PVOH), tend to peel off easily from the polyolefin substrate resulting in loss of barrier properties and poor appearance.

U.S. Pat. No. 4,650,721 describes a process to improve the otherwise poor bonding of EVOH or PVOH in oriented films through the use of tie resins, namely maleic anhydride acid grafted polyolefins.

U.S. Pat. No. 5,153,074 teaches a metallized oriented multilayer film design of EVOH and blends of a maleic anhydride modified propylene homopolymer or copolymer as the substrate to which the EVOH is contiguously adhered. The EVOH layer is used as a metallizing surface for the vapor deposition of aluminum. Again, the use of an adhesion promoting material is essential in this invention. It is known that EVOH is relatively hard to stretch compared to polypropylene. Consequently, only limited grades of EVOH like the one with 48 mole % of ethylene can be co-processed with OPP without forming any surface defects. Using lower ethylene mole % EVOH (e.g. 44% or 38%) in biaxial orientation causes surface defects like stress fractures or process issues like film breaks due to the higher crystallinity of the EVOH.

U.S. Pat. No. 5,175,054 teaches the solution coating of a mixture of solution-grade EVOH or PVOH containing about 80% of vinyl alcohol and aqueous dispersion-grade of the ionomer of the alkali salt of ethylene-methacrylic acid copolymer. This coating is applied to an oriented polymer substrate and subsequently metallized. In this invention, the ionomer acts as an adhesion promoter to assure adequate adhesion of the EVOH or PVOH to the polyolefin (polypropylene) substrate which is otherwise poor without the presence of the ionomer.

U.S. Pat. No. 5,472,753 discloses a polyetheramine-containing laminate structure for beverage bottles. The disclosure of this patent is incorporated herein by reference.

U.S. patent application Ser. Nos. 10/690,709 and 11/107,928 disclose polyetheramine-containing laminate film structures for flexible packaging applications. The disclosures of these patent applications are incorporated herein by reference.

This invention seeks to avoid some of the disadvantages of EVOH containing laminate films.

### SUMMARY OF THE INVENTION

Described are biaxially oriented films that include a polyolefin tie-layer, a layer of polyetheramine polymer contiguously formed on one side of the polyolefin tie-layer, and an optional contiguous polyolefin layer formed on the polyolefin tie-layer side opposite the polyetheramine polymer. The films exhibit exceptional gas barrier characteristics over a polyolefin film alone, rival the gas barrier of EVOH-containing polyolefin films, and the polyetheramine layer exhibits a high surface energy suitable for printing, metallizing, adhesive laminations and coatings. Also described are basefilms for metallizing wherein the polyetheramine polymer layer serves as a metal adhesion layer.

One embodiment is a laminate film including a polyetheramine (also known as epoxy-amine polymer or polyhydroxyamino-ether) resin-containing layer on a first polyolefin resin-containing layer. Preferably, the polyetheramine resin-containing layer is directly on the first polyolefin resin-containing layer and the first polyolefin resin-containing layer includes a tie-layer or adhesion promoting material. The laminate could further include a second polyolefin resin-containing layer on the first polyolefin resin-containing layer. This second polyolefin resin-containing layer could be considered a core layer to provide the bulk strength of the laminate film. Furthermore, the laminate could further include a third polyolefin resin-containing layer on the second polyolefin resin-containing core layer opposite the side with the first polyolefin resin-containing tie-layer.

Preferably, the polyetheramine resin is a copolymer of bis-phenol A diglycidyl ether (BADGE) and resorcinol diglycidyl ether (RDGE) with ethanolamine while the first polyolefin resin-containing tie-layer includes a propylene homopolymer or copolymer grafted with maleic anhydride or a blend of propylene homopolymer or copolymer with a maleic-anhydride grafted propylene homopolymer or copolymer. Alternatively, the first polyolefin resin-containing tie-layer could also include various blends of ethylene propylene copolymers with ethylene polar terpolymers that provide good adhesion between the polyetheramine layer and propylene homopolymer or copolymer core layers.

Preferably, the second polyolefin resin-containing layer includes a propylene homopolymer or copolymer. More preferable is an isotactic propylene homopolymer to act as the core or base layer of the laminate film.

Preferably, the third polyolefin resin-containing layer includes a heat sealable polyolefin. Preferred heat sealable polyolefins include polypropylene copolymers, terpolymers, polyethylene and combinations thereof. In another variation of the third polyolefin resin-containing layer, the heat sealable layer includes an antiblock component. Preferred antiblock components include amorphous silicas, aluminosilicates, sodium calcium aluminum silicate, a crosslinked silicone polymer, and polymethylmethacrylate. Alternatively, the third polyolefin resin-containing layer could also include a winding layer comprising a crystalline polypropylene and an inorganic antiblocking agent.

Preferably, the third polyolefin resin-containing layer includes a winding layer comprising a matte layer of a block copolymer blend of polypropylene and one or more other polymers, the matte layer having a roughened surface while the winding layer is a discharge treated winding layer having a surface for lamination or coating with adhesives or inks. Preferably, the winding layer includes an antiblock component, for example, amorphous silicas, aluminosilicates, sodium calcium aluminum silicate, a crosslinked silicone polymer, and polymethylmethacrylate.

Further preferably, the polyetheramine resin-containing layer is a discharge-treated polyetheramine resin-containing layer. In one variation, the discharge-treated polyetheramine resin-containing layer has a discharge-treated surface formed in an atmosphere of CO₂ and N₂. The laminate film could further include a vacuum deposited metal layer on the polyetheramine resin-containing layer. Preferably, the metal layer has a thickness of about 5 to 100 nm, has an optical density of about 1.5 to 5.0, and includes aluminum. In one variation, the laminate film is an extruded laminate film.

Another embodiment is a method for flexible packaging. The method includes obtaining a laminate film including a polyetheramine resin-containing layer on a first polyolefin resin-containing tie-layer and surrounding the product with the laminate film. Preferably, the product is a food product.

Yet another embodiment, is a biaxially oriented polyolefin multi-layer film with a skin of polyetheramine to enhance barrier and printing properties for flexible packaging purposes. Another embodiment is a metallized biaxially oriented polyolefin multi-layer barrier film. An additional embodiment provides laminate structures of polyolefin layers and polyetheramine layers for barrier applications in flexible packaging.

Another further embodiment is a laminate film including a polyetheramine resin-containing layer on a mixed resin layer including a polyethylene terephthalate resin and a polyolefin resin, wherein preferably the polyolefin resin is a polypropylene but could also be a heat sealable polyolefin such as polypropylene copolymers, terpolymers, polyethylene and combinations thereof. The mixed resin layer could further include a compatibilizer that provides compatibility between the polyethylene terephthalate resin and the polyolefin resin. The compatibilizer could be a polymer having polyolefin molecules and polyethylene terephthalate molecules within the polymer, preferably at the two ends of the polymer chain. In one variation, the mixed resin layer could further include an antiblock component such as amorphous silicas, aluminosilicates, sodium calcium aluminum silicate, a crosslinked silicone polymer and polymethylmethacrylate.

Also included is a method to improve the barrier of biaxially oriented films and metallized films resulting in a high barrier packaging film with excellent gas barrier properties. The method helps solve the problem associated with the prior art of surface defects, processability issues, and limitations of using lower ethylene content EVOH in biaxial orientation.

The laminate film of the invention includes at least a 2-layer laminate film wherein the core layer or substrate layer is an oriented film, either monoaxially or biaxially, the preferred being biaxially oriented. This core or substrate layer may include polyolefins such as propylene homopolymer, ethylene homopolymer, copolymers of propylene and ethylene, copolymers of butene and propylene, terpolymers of ethylene, propylene and butene, or blends thereof combined with an amount of tie-layer or adhesion-promoting resin. Particularly preferred is a blend of propylene homopolymer or copolymer with a maleic anhydride-grafted propylene homopolymer or copolymer. Alternatively preferred is a blend of propylene homopolymer or copolymer with ethylene polar terpolymers that provide good adhesion between the polyetheramine layer and propylene homopolymer or copolymer core layers.

A skin layer of polyetheramine is applied contiguously upon at least one of the surfaces of the substrate layer. The method of applying the polyetheramine layer to the substrate layer can be of various means well known in the art, such as solution coating an aqueous solution of the polyetheramine resin onto the substrate layer by means of a coating roll (e.g. gravure roll) or other coating means, and drying of the coating. In particular, a cost effective method of applying the polyetheramine aqueous solution is by means of a gravure coating roll via an in-line coating method whereby the coating station is placed “in-line” with the film-making line. In this configuration, the coating station is placed between the machine direction orientation section and the transverse direction orientation section of a sequential biaxial orientation line. Thus, the polyetheramine coating is applied on the tie-layer surface of the substrate after machine direction orientation of the substrate but before the transverse direction orientation of the substrate. The transverse direction orientation section's preheat ovens effectively act as a drier to remove the solvent (water in this case), leaving the polyetheramine polymer adhered to the substrate. The substrate is stretched in the transverse direction, thus completing the biaxial orientation process; the amorphous nature of the polyetheramine polymer is particularly well-suited to stretching as well, without cracking or loss of adhesion to the substrate. In the case of a simultaneous biaxial orientation process which does not have a separate machine direction orientation section, the in-line coating station can be placed between the casting section and the orientation oven.

Another method is to employ extrusion coating of the polyetheramine onto the tie-layer portion of the substrate whereby a molten stream of the polyetheramine is coated onto the substrate by means of a die. Another method is to coextrude the polyetheramine along with the substrate tie-layer or tie-resin modified core layer through a compositing die whereupon the molten multilayer film structure is quenched upon a chilled casting roll system or casting roll and water bath system. It is also contemplated to produce a laminate structure in which the polyetheramine layer is sandwiched between two outer film substrates (which may be multilayer structures themselves). The outer film substrates may be the same in composition or not; the polyetheramine in this case can be thought of as a laminating adhesive adhering the two outer substrates together. The two outer substrates would include a suitable tie-layer resin blend as well, either as a mixed resin blend or as a discrete layer as part of the overall respective outer substrate. All these examples can also be metallized via vapor-deposition, preferably a vapor-deposited aluminum layer, with at least an optical density of about 1.5, preferably with an optical density of about 2.0 to 4.0, and even more preferably between 2.3 and 3.2.

Optionally, an additional layer of a heat sealable surface or a winding surface containing antiblock and/or slip additives for good machinability and low coefficient of friction (COF) can be disposed on the polyolefin tie-resin modified substrate layer, opposite the side with the polyetheramine layer. Additionally, if this additional layer is used as a winding surface, its surface may also be modified with a discharge treatment to make it suitable for laminating or converter applied adhesives and inks.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the drawings and description are to be regarded as illustrative in nature and not as restrictive.

### DETAILED DESCRIPTION OF THE INVENTION

It has been found that by using polyetheramine polymers (aka epoxy-amine polymer, polyhydroxy amino ether) in a contiguous layer formed upon a polyolefin or polyester film substrate results in a multilayer film structure exhibiting superior gas barrier properties and an exceptionally high surface energy. Unlike EVOH or related materials such as PVOH, however, no tie-layer or adhesion promoting materials such as anhydride-grafted polyolefins are required to bond the polar layer to a discharge-treated (i.e. corona, flame, or plasma treatment) polyolefin or amorphous copolyesters; nor are primers required to bond to a polyethylene terephthalate film substrate. Adequate adhesion of the polyetheramine is found without the need of such intermediate adhesion promoting layers or tie resins, so long as the substrate has a sufficiently high surface energy such as can be obtained via discharge treatment methods that are well-known in the industry. Thus, the use of tie-layers and specialty multi-layer compositing dies can be avoided. Moreover, because of the amorphous nature of polyetheramine, biaxial orientation of a layer of polyetheramine upon the polyolefin or polyester substrate is easily achieved, with no attendant cracking or peeling of the polyetheramine under stretching forces and temperatures.

In addition, because of the high hydroxyl content of the polyetheramine composition, such a layer's surface energy is sufficiently high enough that no discharge-treatment method is required post-film-forming. This inherently high surface energy makes it readily suitable as a printing, metallizing, coating, or laminating surface. Nevertheless, discharge-treating of the polyetheramine surface can further enhance the bonding, printing, or metallizing performance of this material. However, like EVOH, polyetheramine is sensitive to humidity in that high humidity conditions can negatively impact its gas barrier properties. Thus, like EVOH, polyetheramine is preferably protected against humidity effects if used as part of a multilayer film or laminate, whereby the polyetheramine layer is preferably located between other layers or coated by a metal coating such as a vapor-deposited metal.

Nevertheless, although adequate adhesion of the polyetheramine layer has been found using processing methods such as off-line coating of polyetheramine aqueous solutions to a discharge-treated polyolefin substrate without requiring the use of tie-layer or adhesion-promoting materials, it has been found that when using in-line coating methods in particular, discharge-treatment of the substrate prior to coating is not always sufficient to ensure adequate adhesion of the polyetheramine layer to the polyolefin substrate layer. Even though a discharge-treatment method is employed prior to the in-line coating station (i.e. after machine direction orientation in a sequential biaxial orientation method but prior to the in-line coating station) and surface energies of 40 dyne-cm/cm² or more are obtained prior to coating, it has been found that after the transverse orientation portion of the process, the polyetheramine layer can be easily delaminated from the polyolefin substrate.

Without being bound to any theory, it is believed that during the transverse orientation process, two phenomena are occurring: 1) The surface area of the substrate greatly increases, thus greatly reducing the per-unit area density of the active treated sites for the polyetheramine polymers to adhere adequately; 2) During the preheating and stretching sections of the transverse direction orientation oven, the active treated sites and functional groups imparted by the discharge treatment method, migrate from the surface of the polyolefin substrate into the substrate itself, thus decreasing the amount of active sites for adhesion. Thus, other methods are preferably employed to help maintain robust adherence of the polyetheramine layer to the substrate during and after the orientation process.

Phenoxy-type thermoplastics, including polyhydroxy ether, polyhydroxy ester ethers, and polyhydroxy amino ethers, are described in the literature such as Polymer Preprints, 34(1), 904-905 (1993). Polyhydroxy amino ether (PHAE), also called polyetheramine, is an epoxy-based thermoplastic. Its repeating unit is composed of aromatic ether and ring or linear amine in the backbone chain, and hydroxyl groups in the pendants from the opening of the epoxy groups. The basic PHAE is made of bis-phenol A diglycidyl ether (BADGE) and ethanol amine. Property modification can be achieved by copolymerization of BADGE and resorcinal diglycidyl ether (RDGE) with ethanol amine which improves gas barrier properties. The amount of the RDGE component in the PHAE copolymer is typically important in determining the effectiveness of the gas barrier properties. Increasing the percentage by weight of the RDGE component in the copolymer, improves further the oxygen gas barrier properties as shown in Table A (from DOW CHEMICAL COMPANY technical report “Building BLOX®—New Thermoplastic Adhesive and Barrier Resins” by Terry Glass and Marie Winkler, 2001).

TABLE A

| % RDGE | O2TR (cc/m²/day |
|---|---|
| 25 | 5.9 |
| 30 | 3.1 |
| 50 | 0.62 |

U.S. Pat. No. 5,275,853 describes the composition and process of making polyetheramine. The polyetheramine for the laminate film of this invention is preferably made by known process such as the process of U.S. Pat. No. 5,275,853.

In one embodiment of the invention, the laminate film includes a mixed resin layer. The mixed resin layer includes an isotactic polypropylene or ethylene-propylene copolymer resin layer blended with an amount of maleic anhydride-grafted propylene homopolymer or maleic anhydride-grafted ethylene propylene copolymer, an ethylene polar terpolymer or blends thereof, with one side discharge-treated for high surface energy suitable for printing or coating. The laminate film preferably also includes an isotactic propylene homopolymer core layer disposed on one side of the said mixed resin layer, opposite the discharge-treated side, a heat sealable ethylene-propylene-butene terpolymer layer coextruded onto one side of the core layer opposite the mixed resin layer side, and a polyetheramine layer coated onto the discharge-treated surface of the mixed resin layer.

The polypropylene resin core layer is preferably a crystalline polypropylene of a specific isotactic content and can be uniaxially or biaxially oriented. Crystalline polypropylenes are generally described as having an isotactic content of about 90% or greater. Suitable examples of crystalline polypropylenes for this invention are FINA 3270 and EXXONMOBILE PP4772. These resins also have melt flow rates of about 0.5 to 5 g/10 min, a melting point of about 163-167° C., a crystallization temperature of about 108-126° C., a heat of fusion of about 86-110 J/g, a heat of crystallization of about 105-111 J/g, and a density of about 0.90-0.91. The core resin layer is typically 5 μm to 50 μm in thickness after biaxial orientation, preferably between 10 μm and 25 μm, and more preferably between 12.5 μm and 17.5 μm in thickness. Additionally, a small amount of inorganic antiblocking agent may be optionally added up to 1000 ppm to this resin layer. Preferably 300-500 ppm of antiblock may be added. Suitable antiblock agents comprise those such as inorganic silicas, sodium calcium aluminosilicates, crosslinked silicone polymers such as polymethylsilsesquioxane, and polymethylmethacrylate spheres. Typical useful particle sizes of these antiblocks range from 1-12 um, preferably in the range of 2-6 um.

The mixed resin layer preferably includes a propylene homopolymer, ethylene-propylene copolymer, propylene-butene copolymer, ethylene-propylene-butene copolymer, ethylene-butene copolymer, or butene homopolymer, either alone or in combination with each other. The mixed resin layer also preferably includes a maleic anhydride-grafted propylene homopolymer or maleic anhydride-grafted ethylene-propylene copolymer. More preferably, the mixed resin layer includes a blend of propylene homopolymer and maleic anhydride-grafted ethylene-propylene copolymer. This mixed resin blend layer acts as the “tie-layer” to bond effectively the polyetheramine layer to the propylene homopolymer core layer. A suitable formulation for this mixed resin layer is a blend of TOTAL EOD04-37 mini-random propylene homopolymer or TOTAL 3576X propylene homopolymer with MITSUI ADMER QF551A maleic anhydride-grafted ethylene propylene copolymer. MITSUI ADMER QF500A maleic anhydride-grafted propylene homopolymer can also be used. The amount of anhydride in these grafted polymers is about 0.12% to 0.15%. The maleic anhydride-grafted propylene-containing polymers can contain some ethylene-propylene rubber or it may not. The amount of maleic anhydride-grafted propylene-containing polymer in the mixed resin blend is about 5% to 100%, preferably 10-50%, and more preferably 15-30%.

Alternatively, the mixed resin tie-layer can be comprised of a blend of: ethylene-propylene copolymer and ethylene polar terpolymers such as ethlyene-butyl acrylate-maleic anhydride copolymer and/or ethylene-glycidal methacrylate-methyl acrylate copolymer. The ethylene-propylene copolymer (EP copolymer) can be of any number of commercially available EP copolymers, ranging from 1% ethylene to about 70% ethylene. Suitable EP copolymers suitable for this tie-layer blend are for example, TOTAL 8473 (a nominal 4% ethylene content EP copolymer) and LANXESS BUNA EP-T-2070-P (a nominal 65-71% ethylene content EP copolymer). Preferably, the EP copolymer component of this tie-layer blend is in the 3-6% ethylene content range. Preferred ethylene polar terpolymers for this tie-layer blend are such as those available from ARKEMA: LOTADER 4210 (an ethylene-butyl acrylate-maleic anhydride terpolymer) or LOTADER AX8900 (an ethylene-glycidal methacrylate-methyl acrylate terpolymer). LOTADER 4210 is a copolymer of about 91% ethylene, 6% butyl acrylate, and 4% maleic anhydride; it should be noted that LOTADER 4210 is not a grafted maleic anhydride polymer like ADMER QF551A or QF500A. LOTADER AX8900 is a copolymer of about 67% ethylene, 8% glycidal methacrylate, and 25% methyl acrylate. The blending ratio of this alternate tie-layer formulation is 0-95% EP copolymer- to 100%-5% of the ethylene polar terpolymer respectively. Preferred is about 10% to 50% of the ethylene polar terpolymer, more preferred is 20-40% of the ethylene polar terpolymer, with the respective balance made up of the EP copolymer.

The mixed resin tie-layer can be coextruded on one side of the core layer having a thickness after biaxial orientation between 0.1 and 5 μm, preferably between 0.5 and 3 μm, and more preferably between 0.5 and 1.0 μm. For the mixed resin layer blend, it is also contemplated to add an antiblock to aid in film handling. A small amount of inorganic antiblocking agent may be optionally added up to 1000 ppm to this resin layer. Preferably 300-500 ppm of antiblock may be added. Suitable antiblock agents include those such as inorganic silicas, sodium calcium aluminosilicates crosslinked silicone polymers such as polymethylsilsesquioxane, and polymethylmethacrylate spheres. Preferred useful particle sizes of these antiblocks range from 1-12 um, more preferably in the range of 2-6 um.

The mixed resin tie-layer can be surface treated with either a corona-discharge method, flame treatment, atmospheric plasma, or corona discharge in a controlled atmosphere of nitrogen, carbon dioxide, or a mixture thereof. The latter treatment method in a mixture of CO₂ and N₂ is preferred. This method of discharge treatment results in a treated surface that comprises nitrogen-bearing functional groups, preferably 0.3% or more nitrogen in atomic %, and more preferably 0.5% or more nitrogen in atomic %. This treated mixed resin layer can then be metallized, printed, coated, extrusion or adhesive laminated. Preferably, it is coated with a layer of polyetheramine.

A heat sealable layer or non-heat sealable layer may be coextruded with the core layer opposite the mixed resin layer having a thickness after biaxial orientation of between 0.2 and 5 μm, preferably between 0.6 and 3 μm, and more preferably between 0.8 and 1.5 μm. The heat sealable layer may contain an anti-blocking agent and/or slip additives for good machinability and a low coefficient of friction in amount preferably about 0.05-0.5% by weight of the heat-sealable layer. The heat sealable layer is preferably a copolymer of propylene, either ethylene-propylene or butylene-propylene, and preferably includes a ternary ethylene-propylene-butene copolymer. A suitable heat sealable terpolymer resin is SUMITOMO SPX78H8. Preferably if the invention includes a non-heat sealable, winding layer, this layer will include a crystalline polypropylene with anti-blocking and/or slip additives or a matte layer of a block copolymer blend of polypropylene and one or more other polymers whose surface is roughened during the film formation step so as to produce a matte finish on the winding layer. Preferably, the surface of the winding layer is discharge-treated to provide a functional surface for lamination or coating with adhesives and/or inks.

The coextrusion process includes a three-layered compositing die. The polymer core layer is sandwiched between the mixed, resin tie-layer and the heat sealable or winding layer. The three layer laminate sheet is cast onto a cooling drum whose surface temperature is controlled between 20° C. and 60° C. to solidify the non-oriented laminate sheet. The non-oriented laminate sheet is stretched in the longitudinal direction at about 135 to 165° C. at a stretching ratio of about 4 to about 5 times the original length and the resulting stretched sheet is cooled to about 15° C. to 50° C. to obtain a uniaxially oriented laminate sheet. The uniaxially oriented laminate sheet is introduced into a tenter and preliminarily heated between 130° C. and 180° C., and stretched in the transverse direction at a stretching ratio of about 7 to about 12 times the original length and then heat set to give a biaxially oriented sheet. The biaxially oriented film has a total thickness between 6 and 40 μm, preferably between 10 and 20 μm, and most preferably between 12 and 18 m.

The polyetheramine layer is preferably an aqueous solution-coated onto the mixed resin tie-layer side of the laminate film structure formed by coextrusion. The polyetheramine polymer is preferably 10-70% RDGE comonomer content, more preferably 30-50% RDGE comonomer content. The % solids of the aqueous solution is from 10-50%, preferably 15-40%, and more preferably 25-35% with a viscosity of less than 50 cps. After drying, the dry coating weight of the polyetheramine layer is 0.3-5 mg/in², preferably 0.5-3.0 mg/in², and more preferably 0.6-1.5 mg/in². Suitable types of polyetheramine is that obtainable from DOW CHEMICALS under the tradename “BLOX®” or from ICI Packaging Coatings under the tradename “OXYBLOC®” In particular, BLOX® 5000 series grade is suitable for solution coating which has an RDGE comonomer content of 50% in the polyetheramine polymer. ICI's polyetheramine coating grade OXYBLOC®670C1370 is also suitable and can be made available with RDGE comonomer content of 30%, 40%, and 50% or other amounts. The resulting clear film was tested for gas barrier properties and adhesion of the coating to the polypropylene substrate. The aqueous coating can be applied either “in-line” or “out-of-line.” In an “in-line” coating, the coating station is located after the machine direction stretching process of a monoaxial or biaxial orientation process and dried in a drying oven or using the tenter oven preheating zones as a dryer. In the case of biaxial orientation, the coated monoaxially stretched film is then stretched in the transverse direction. An advantage of this process is that the orientation and coating of the invention can essentially be done in one processing step.

It is often beneficial to in-line discharge treat the monoaxial substrate prior to the coating station so that the aqueous solution adequately “wets” the substrate surface for consistent coating weight, drying, and appearance. In an “out-of-line” coating process, the finished monoaxial or biaxial film is wound up in a roll form, and is mounted on a separate coating machine. Again, the monoaxial or biaxial film substrate should have the desired surface for coating with the polyetheramine solution discharge-treated in order that the solution adequately wets the surface. This separate coating line will then apply the solution, dry it, and rewind the finished product. The preferred method to coat in this embodiment is via the in-line coating process. In this case, the use of the mixed resin tie-layer is most advantageous to improve adhesion of the polyetheramine to the propylene-based resin substrate. In out-of-line coating, the use of the mixed resin tie-layer was not necessary for adequate bonding of the polyetheramine to the propylene-based substrate so long as surface discharge-treatment of the substrate was adequate for the aqueous solution to wet-out. Unexpectedly, it was found that surface discharge-treating of the monoaxially stretched propylene-based substrate in the in-line process did not provide adequate adhesion of the polyetheramine to the substrate; however, the addition of a polar additive component such as maleic anhydride-grafted EP copolymer or ethylene polar terpolymer provided excellent adhesion of the polyetheramine to the substrate.

In another embodiment, the mixed resin layer need not be a discrete layer coextruded onto one side of the core layer. The core layer itself can include a blend of the propylene homopolymer and maleic anhydride-grafted propylene homopolymer or copolymer; or a propylene homopolymer, ethylene-propylene copolymer, and ethylene polar terpolymer. In this embodiment, the polyetheramine coating can be applied directly to one side of the mixed resin core layer.

The polyetheramine resin can also be extrusion-coated onto the polymer substrate rather than solution-coated. DOW CHEMICAL BLOX® grades for extrusion-coating that are suitable include, but are not limited to, BLOX® 4000 series and 0000 series. Similar to the solution-coating method, the extrusion-coating can be done either in-line—whereby the extrusion coating station is located after the first direction stretching process onto the monoaxially oriented film—or out-of-line whereby the extrusion-coating process is done on a separate machine onto the monoaxially or biaxially stretched substrate. It may also be desirable for the substrate to have the surface designated for coating to be discharge-treated in order that adequate adhesion of the BLOX® resin is obtained and to contain a tie-layer resin component or layer.

The polyetheramine layer may also be applied-via-coextrusion with the substrate layer. In this case, a compositing die is used to combine the melt streams of the polyetheramine extrudate with the substrate extrudate which is either a polyolefin of polyester. In this case, no discharge-treatment of the substrate is necessary as enough intermolecular mixing at the interface of the polyetheramine extrudate and substrate extrudate assures adequate bonding of the two layers. However, it may be beneficial to ensure adequate adhesion by adding the tie-layer blend mixtures of maleic anhydride-grafted polyolefins or ethylene polar terpolymers. This coextrudate can then be cast onto a chill roll, quenched, then monoaxially or biaxially stretched into the final film product. The coextruded polyetheramine skin resin layer in this case has a thickness of between 0.2 and 2 μm, preferably between 0.5 and 1.5 μm, more preferably 0.75-1 um, after biaxial orientation.

A preferred embodiment is to metallize the surface of the polyetheramine layer. The unmetallized laminate sheet is first wound in a roll. The roll is placed in a metallizing chamber and the metal vapor-deposited on the polyetheramine resin layer surface. The metal film may include titanium, vanadium, chromium, manganese, iron, cobalt, nickel, copper, zinc, aluminum, gold, or palladium, the preferred being aluminum. The metal layer shall have a thickness between 5 and 100 nm, preferably between 20 and 80 nm, more preferably between 30 and 60 nm; and an optical density between 1.5 and 5.0, preferably between 2.0 and 4.0, more preferably between 2.3 and 3.2. The metallized film is then tested for oxygen and moisture permeability, optical density, metal adhesion, and film durability. This invention will be better understood with reference to the following examples, which are intended to illustrate specific embodiments within the overall scope of the invention.

### EXAMPLE 1

A 3-layer coextrusion article including a core layer of a polypropylene resin upon one side is coextruded a mixed resin tie-layer of 30% ADMER QF551A maleic anhydride-grafted EP copolymer and 70% TOTAL EOD04-37 polypropylene resin. A layer of terpolymer sealant is disposed upon the side of the core layer opposite the mixed resin layer. This layer was coated in-line with a solution of polyetheramine resin comprising 50% RDGE, upon the mixed layer surface opposite the core layer. The total thickness of this film substrate after biaxial orientation is 70 G or 0.7 mil. The thickness of the respective mixed resin tie-layer and sealant skin layers after biaxial orientation is 2-4 G and 4-6 G. The core is comprised of polypropylene and 300 ppm of antiblock additive such as silica of about 6 um in average particle size. The thickness of the core layer after biaxial orientation is 60-64 G. The mixed resin tie-layer and core layer is melt extruded at 450-550° F. where the propylene homopolymer of the core layer is EXXONMOBIL PP4772.

The sealant layer comprises an ethylene-propylene-butylene terpolymer such as SUMITOMO SPX78H8 and 4000 ppm of an inorganic antiblock additive such as TOSHIBA. TOSPEARL 120, a crosslinked silicone polymer of nominal 2.0 um particle size and is melt extruded at 400-480° F. The 3-layer coextrudate was passed through a flat die to be cast on a chill drum of 100-180° F. The formed cast sheet was passed through a series of heated rolls at 210-270° F. with differential speeds to stretch in the machine direction (MD) from 4 to 6 stretch ratio. The monoaxially stretched substrate was in-line coated with the polyetheramine via a gravure roll with an OXYBLOC® 6701370 series aqueous solution, which has about 50% co-monomer of RDGE. The OXYBLOC®D solution comprises the epoxy-amine polymer dispersed in water. The % solid in water was about 30% and the solution viscosity less than 50 cps. This was followed by transverse direction (TD) stretching from 8 to 10 stretch ratio in the tenter oven at 310-350° F. The OXYBLOC®-coated substrate was passed through the transverse orientation oven which acted as a drying oven to achieve a dry coating weight of about 0.6 mg/in² or about 0.75 um in thickness. The dried coating had a T_{g} ranging from 50 to 95° C. The coated and dried resultant clear film was tested for adhesion properties of the polyetheramine layer to the substrate.

### EXAMPLE 2

A process similar to Example 1 was repeated except that the mixed resin layer comprised a blend of 50% ADMER QF551A. The clear film was tested for adhesion properties of the polyetheramine layer to the substrate.

### EXAMPLE 3

A process similar to Example 1 was repeated except that the mixed resin layer comprised 100% ADMER QF551A. The resultant clear film was then tested for adhesion properties of the polyetheramine layer to the substrate.

### EXAMPLE 4

A process similar to Example 1 was repeated except that the mixed resin layer comprised a blend of 20% LOTADER 4210 and 80% TOTAL 8473. The resultant clear film was then tested for adhesion properties of the polyetheramine layer to the substrate.

### EXAMPLE 5

A process similar to Example 1 was repeated except that the mixed resin layer comprised a blend of 40% LOTADER AX8900 and 60% TOTAL 8473. The resultant clear film was then tested for adhesion properties of the polyetheramine layer to the substrate.

### COMPARATIVE EXAMPLE

A process similar to Example 1 was repeated except that the mixed resin blend layer was comprised only of 100% TOTAL EOD04-37 (0% maleic anhydride-grafted polyolefin or ethylene polar terpolymer). The resultant clear film was then tested for adhesion properties of the polyetheramine layer to the substrate.

The adhesion properties of the Examples and Comparative Example (“CEx.”) are shown in Table 1.

TABLE 1

| | % Admer QF551A | PHAE Adhesion |
|---|---|---|
| Example | or Lotader resin | % peel-off¹ |
| 1 | 30 | 4 |
| 2 | 50 | 4 |
| 3 | 100 | 4 |
| 4 | 20 | 4 |
| 5 | 40 | 4 |
| CEx. | 0 | 1 |

¹Adhesion is graded 1-4, with 4 = excellent adhesion, and 1 = poor adhesion

The resultant clear films of Examples 1 to 5 provide excellent adhesion of the polyetheramine layer to the substrate. The inclusion of tie-layer blends including maleic anhydride-grafted polyolefins and/or ethylene polar terpolymers significantly improved the adhesion of the polyetheramine layer to the substrate when compared to the Comparative Example wherein no such tie-layer blend components were used. Virtually no polyetheramine could be removed via tape test in Examples 1-5, whereas nearly 100% of the polyetheramine was removed in the Comparative Example.

Test Methods

The various properties in the above examples were measured by the following methods:

Oxygen transmission rate of the film was measured by using a MOCON OXTRAN 2/20 unit substantially in accordance with ASTM D3985. In general, the preferred value was an average value equal to or less than 15.5 cc/m²/day with a maximum of 46.5 cc/m²/day.

Moisture transmission rate of the film was measured by using a MOCON PERMATRAN 3/31 unit measured substantially in accordance with ASTM F1249. In general, the preferred value was an average value equal to or less than 0.155 g/m²/day with a maximum of 0.49 g/m²/day.

Optical density was measured using a TOBIAS ASSOCIATES model TBX transmission densitometer. Optical density is defined as the amount of light reflected from the test specimen under specific conditions. Optical density is reported in terms of a logarithmic conversion. For example, a density of 0.00 indicates that 100% of the light falling on the sample is being reflected. A density of 1.00 indicates that 10% of the light is being reflected; 2.00 is equivalent to 1%, etc.

Polar skin adhesion was measured by adhering a strip of 1-inch wide 610 tape to the polar skin surface of a single sheet of film and removing the tape from the surface. The amount of polar skin removed was rated qualitatively as follows:

4=Excellent=0-10% polar skin removed

3=Good=11-30% polar skin removed

2=Fair=31-50% metal removed

1=Poor=>50% polar skin removed

In general, preferred values were Excellent to Good (4-3).

Appearance was rated qualitatively on the presence of cracks on the surface of the film.

Surface chemistry of the discharge-treated surface was measured using ESCA surface analysis techniques. A PHYSICAL ELECTRONICS model 5700LSci X-ray photoelectron/ESCA spectrometer was used to quantify the elements present on the sample surface. Analytical conditions used a monochromatic aluminum x-ray source with a source power of 350 watts, an exit angle of 50°, analysis region of 2.0 mm×0.8 mm, a charge correction of C—(C,H) in C 1s spectra at 284.6 eV, and charge neutralization with electron flood gun. Quantitative elements such as O, C, N were reported in atom %.

Wetting tension of the surfaces of interest was measured substantially in accordance with ASTM D2578-67. In general, the preferred value was an average value equal to or more than 40 dyne/cm with a minimum of 38 dyne/cm.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A laminate film comprising:
a polyetheramine resin-containing layer comprising at least 30% resorcinol diglycidyl ether (RDGE) comonomer content; and
a first polyolefin resin-containing layer comprising a tie-layer resin.

2. The laminate film of claim 1, wherein the polyetheramine resin-containing layer is in direct contact with the first polyolefin resin-containing layer.

3. The laminate film of claim 1, further comprising a second polyolefin resin-containing layer on the first polyolefin resin-containing layer.

4. The laminate film of claim 1, wherein the polyetheramine resin is a copolymer of bis-phenol A diglycidyl ether and at least 30% resorcinol diglycidyl ether with ethanolamine.

5. The laminate film of claim 1, wherein the first polyolefin resin-containing layer comprises:
propylene homopolymer, ethylene-propylene copolymer, ethylene-propylene-butene terpolymer, propylene-butene copolymer, butene homopolymer, or blends thereof; and
a maleic anhydride-grafted propylene homopolymer or copolymer.

6. The laminate film of claim 1, wherein the first polyolefin resin-containing layer comprises an ethylene-propylene copolymer and an ethylene polar terpolymer.

7. The laminate film of claim 3, wherein the second polyolefin resin-containing layer comprises an isotactic propylene homopolymer.

8. The laminate film of claim 3, wherein the second polyolefin resin-containing layer comprises a heat sealable polyolefin selected from the group consisting of propylene copolymers, terpolymers, polyethylene and combinations thereof.

9. The laminate film of claim 8, wherein the heat sealable layer comprises an antiblock component selected from the group consisting of amorphous silicas, aluminosilicates, sodium calcium aluminum silicate, crosslinked silicone polymers, and polymethylmethacrylate

10. The laminate film of claim 1, wherein the first polyolefin resin-containing layer is a discharge-treated polyolefin resin-containing layer.

11. The laminate film of claim 3, wherein the second polyolefin resin-containing layer comprises a winding layer comprising a crystalline polypropylene and an inorganic antiblocking agent.

12. The laminate film of claim 3, wherein the second polyolefin resin-containing layer comprises a winding layer comprising a matte layer of a block copolymer blend of polypropylene and one or more other polymers, the matte layer having a roughened surface.

13. The laminate film of claim 11, wherein the winding layer is a discharge treated winding layer having a surface for lamination or coating with adhesives or inks.

14. The laminate film of claim 11, wherein the winding layer comprises an antiblock component selected from the group consisting of amorphous silicas, aluminosilicates, sodium calcium aluminum silicate, crosslinked silicone polymers, and polymethylmethacrylate.

15. The laminate film of claim 1, wherein the polyetheramine resin-containing layer is a discharge-treated polyetheramine resin-containing layer.

16. The laminate film of claim 15, wherein the discharge-treated polyetheramine resin-containing layer has a discharge-treated surface formed in an atmosphere of CO₂ and N₂.

17. The laminate film of claim 1, further comprising a vacuum deposited metal layer on the polyetheramine resin-containing layer.

18. The laminate film of claim 17, wherein the metal layer has a thickness of 5 to 100 nm.

19. The laminate film of claim 17, wherein the metal layer has an optical density of 1.5 to 5.0.

20. The laminate film of claim 17, wherein the metal layer comprises aluminum.

21. The laminate film of claim 1, wherein the laminate film is an extruded laminate film.

22. A method for packaging a product comprising:
obtaining a laminate film comprising a polyetheramine resin-containing layer comprising at least 30% resorcinol diglycidyl ether (RDGE) comonomer content and a first polyolefin resin-containing layer comprising a tie-layer resin; and
surrounding a product with the laminate film.

23. The method of claim 22, wherein the product is a food product.

24. A laminate film comprising;
a polyetheramine resin-containing layer comprising at least 30% resorcinol diglycidyl ether (RDGE) comonomer content;
a mixed resin layer comprising a polyethylene terephthalate resin and a polyolefin resin; and
a tie-layer resin.

25. The laminate film of claim 24 further comprising a compatibilizer.

26. The laminate film of claim 24, further comprising an antiblock component.
